(19) United States
(12) Patent Application Publication
(10) Pub. No.: US 2001/0032089 A1
(43) Pub. Date: Oct. 18, 2001

(54) Method of managing and updating a contact database

(76) Inventor: Douglas Schiller, Los Angeles, CA (US)

Correspondence Address: Kirschstein, Ottinger, Israel & Schiffmiller, P.C., 489 Fifth Avenue, New York, NY, 10017-6105, US

(21) Appl. No.: 09/730,065

(22) Filed: Dec. 5, 2000

Related U.S. Application Data
(60) Provisional application No. 60/169,390, filed on Dec. 6, 1999.

(51) Int. Cl. G06F 17/60; G06F 7/00; G06F 17/30

(52) U.S. Cl. 705/1; 705/7; 705/14; 707/9

(57) ABSTRACT

A database is managed by at least partly shifting the burden of maintaining contact information current to the individuals registered in the database. A database manager will, if necessary, automatically generate requests for updated information, and provide incentives upon compliance with such requests.

### CROSS REFERENCE TO RELATED APPLICATIONS

This application claims priority to U.S. Provisional Application Ser. No. 60/169,390, filed Dec. 6, 1999.

### BACKGROUND OF THE INVENTION

1. Field of the Invention

This invention generally relates to managing and updating a contact database in which information identifying individuals are stored and, more particularly, to providing an incentive for a respective individual if the contact information for the respective individual has been updated, especially in response to a request automatically generated by a database manager.

2. Description of the Related Art

Contact databases for storing information, such as names, residence addresses, business addresses, telephone numbers, facsimile numbers and e-mail addresses are well known, both in printed and electronic versions. A manager of the database is responsible for obtaining this information, and for maintaining this information current. Failure to keep the information up-to-date renders the database useless as a contact tool.

However, maintaining the information current is not an easy task for the manager because individuals frequently change jobs, numbers and addresses. The database manager typically has no advance knowledge of when the stored information has become stale. The manager must, therefore, all too often, rely on the individuals themselves to remember to advise the manager with the new information. However, individuals often forget to do this, rendering the integrity of the database unreliable.

### SUMMARY OF THE INVENTION

### OBJECTS OF THE INVENTION

It is an object of this invention to maintain contact information current by shifting the burden, at least in part, to the individuals themselves.

It is another object of this invention to generate automatic requests from the manager to the individuals to update their information.

Still another object of this invention is to provide incentives when the individuals have complied with the requests for updated information.

### FEATURES OF THE INVENTION

In keeping with these objects, one feature of this invention resides, briefly stated, in a method of managing a contact database, comprising the steps of offering an initial incentive to respective individuals to store contact information in the database, and providing the initial incentive after the contact information has been stored; and offering subsequent incentives to the respective individuals to update their contact information, and providing each subsequent incentive after the contact information has been updated.

Another feature of this invention relates to a method of updating a contact database, comprising the steps of storing contact information, e.g., names, addresses and numbers, indicative of individuals in the database; generating requests from a database manager to the individuals that the contact information be updated; and providing an incentive to a respective individual if the contact information for the respective individual has been updated in response to a respective request.

For a database that is managed on-line, the requests are preferably transmitted by e-mail messages directly to the individuals themselves. The requests are preferably electronically generated once predetermined thresholds, e.g., the passage of a set period without any updates, are reached. The incentives are preferably credits or coupons for some product or service.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a computer monitor screenshot of a database screen with exemplary fields filled in by an individual desiring to be registered or desiring to update his registry;

FIG. 2 is another screenshot of what an individual would see upon querying the database;

FIG. 3 is an e-mail screenshot from an individual to a database manager;

FIG. 4 is an e-mail screenshot from the database manager to an individual; and

FIG. 5 is a screenshot of a desktop of an individual registered with the database and desiring a “do not disturb” status.

### DETAILED DESCRIPTION OF PREFERRED EMBODIMENT

A method of updating a contact database in which contact information, such as names, addresses, phone numbers, facsimile numbers, cell phone numbers, e-mail addresses and the like both for personal and business purposes, is stored requires a database manager to request updated information, and provides incentives upon compliance with such requests.

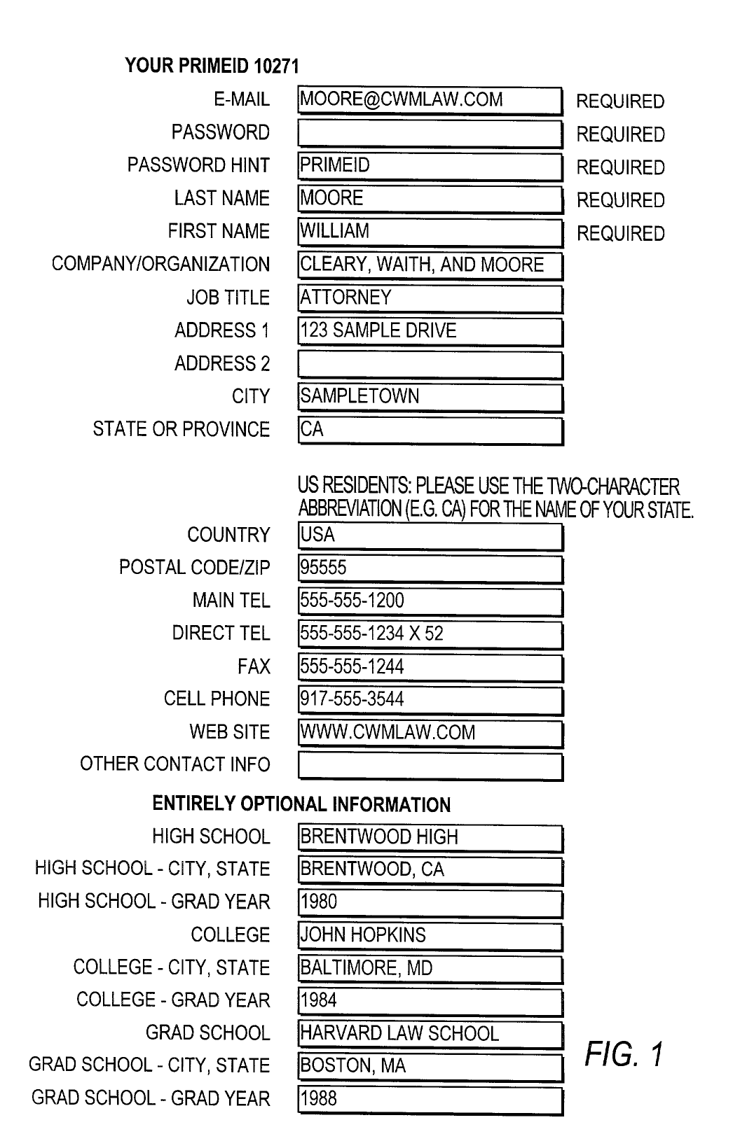

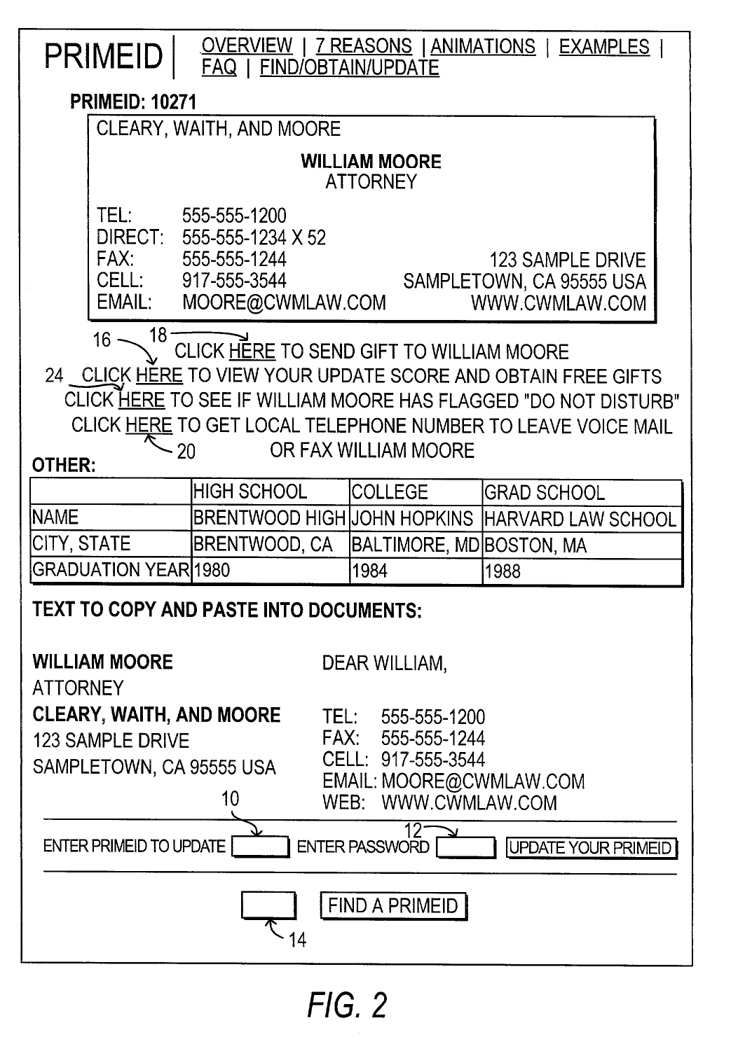

FIG. 1 depicts a computer monitor screenshot of a database screen with exemplary fields filled in, either during a first-time registry of an individual with the database, or during a subsequent-time update of the registry. Each registered individual is assigned a unique user identification number, e.g., “10271”. Any individual querying the database, including the registered individual himself, will retrieve a screenshot as depicted in FIG. 2. Field 10 enables the registered individual to update the database. Field 12 enables entry of a password. Field 14 enables a search for another registered individual.

In an on-line managed database, the manager will preferably generate requests for updated information in the form of an e-mail message and send it to a respective individual's last known e-mail address. The individual is then prompted to respond, either with updated information or with a message that no update is necessary.

The requests are preferably automatically generated when certain conditions exist or thresholds met. For example, if an individual has not updated his or her information for an unacceptably long time, i.e., six months, then the request is automatically generated. If the manager knows that an area code has been changed, then an automatically generated request is sent to all individuals in that area code.

A scoring system can be used to determine the integrity of the stored data. For example, points can be awarded to any individual that regularly updates his information. The number of points can be the sum of the number and type of fields updated in the database, as well as the frequency of the updates. Automatic generation of requests can be generated if the individual's score falls below a certain number. One can check his score by actuating link 16 in FIG. 2. Reports can be generated in which the scores are tabulated for analysis.

Incentives are awarded based on the scoring system. For example, a credit card company will agree to reduce its annual membership fee by a certain amount if the score remains above a certain value for a number of months. A retail store will agree to award a money-saving coupon for a high score for a certain time period. Other incentive programs managed by the database manager can be implemented. Several pre-designed incentive programs will be offered by the database manager to simplify adoption of the system; for example, the issuance of computer generated coupons, or promotional items like pens and notepads.

All or some of the various fields in the database can be marked as being “public” or “private,” thereby respectively granting or denying access to anyone querying the database for the information contained in the various fields. In the preferred embodiment, the information is uploaded and downloaded via an on-line connection using a dial-up modem. However, the information can also be uploaded and downloaded via a push button keypad on a telephone. For example, one can query a local database number, and key in an identifying number for an individual. The database will respond with a menu of choices, e.g., the current telephone number for that individual, or a “do not disturb” message for that individual, and the like. The database can be programmed to dial the telephone number for that individual for a fee.

Other features can be incorporated into the database. In the on-line version, a web browser will display a screen, as shown in FIG. 2, identifying each individual and containing that individuals' contact information. Also displayed on the screen can be an icon, or link 18 in FIG. 2, depicting a gift. If the person viewing the screen “clicks” on the gift icon, then the gift will be sent to the individual identified on the screen. This feature greatly simplifies gift giving and insures that the most up-to-date information, as verified by the gift recipient, is used to mail the gift. It is simplified further because the name of the gift recipient can be automatically embossed on the gift.

Another icon, or link 20 in FIG. 2, would display a telephone number that is local to the viewing party that could receive faxes and voice mail messages that would then be forwarded to the receiving party's preferred e-mail address.

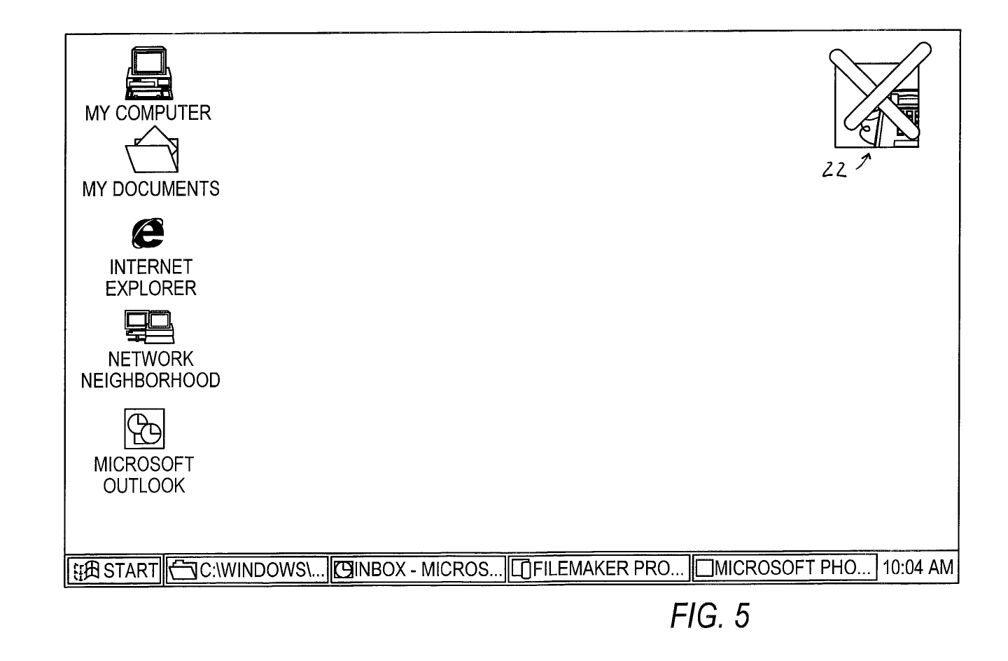

Other icons or “message links” on the screen can be clicked to render other functions operative. For example, a “do not disturb” button icon 22, as seen in the desktop view of FIG. 5, is useful when activated by the individual registered with the database to prevent others from contacting him, either via telephone or via an on-line connection. The “do not disturb” button 22 will be activated and deactivated by the individual on his personal computer. Another can check whether the button 22 has been activated by actuating link 24 in FIG. 2.

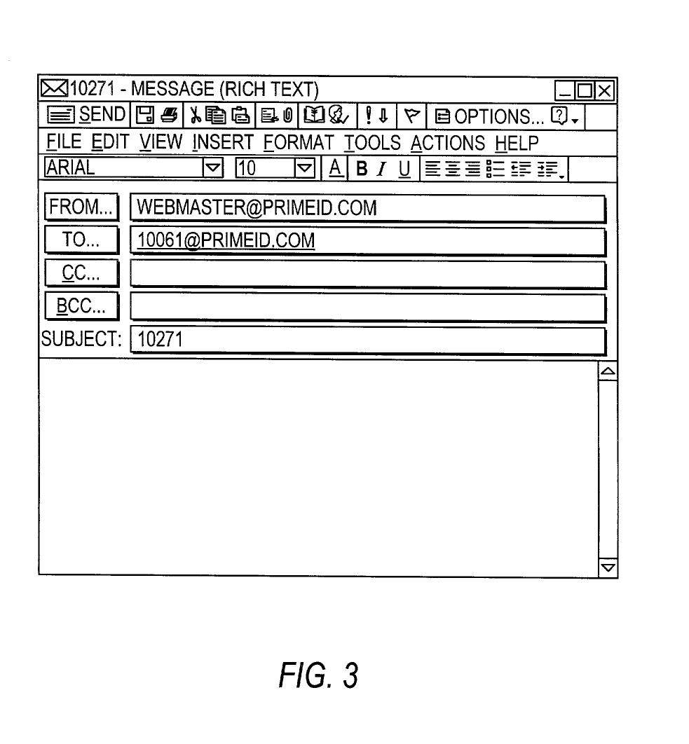

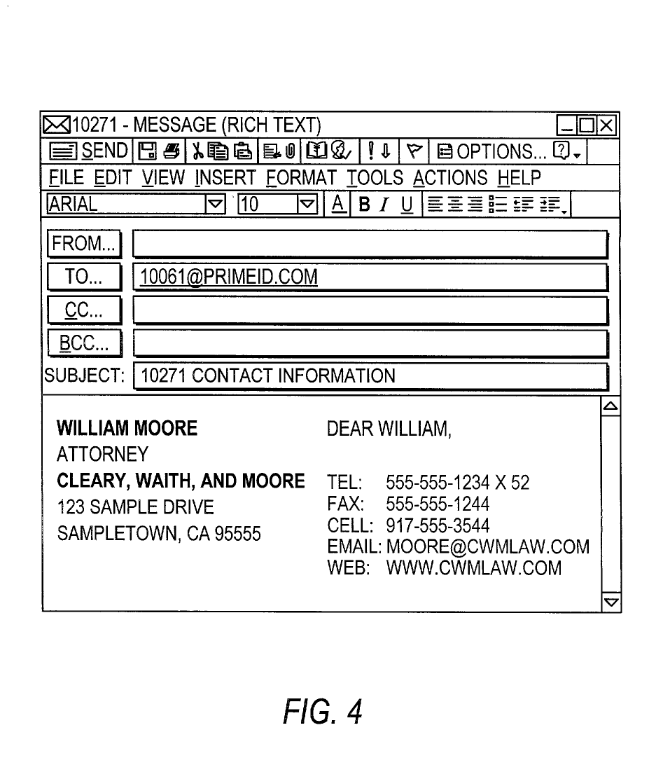

FIG. 3 depicts an e-mail screen from an individual to the database, whereas FIG. 4 depicts a responsive e-mail message from the database manager to the inquiring individual.

Another unique feature is that there is a reconciliation/matching capability that checks to see if people who join the contact database are already on a pre-existing database. More particularly, an organization uploads a large name database to the database manager. These names, for example, a thousand in number, are entered en masse by the organization. Most likely, the names do not have a unique user identification number. The organization then tells its membership/customer base that they should join the online database in exchange for rewards. As people start joining, some of the people are already on the database, and are termed “old”. Others are not already on the database, and are termed “new”. Both the old and new people are termed “joiners”.

The database manager then cycles through the joiners to separate the old and new people. An old joiner is someone where the first and last names match exactly and the name of that person's organization matches exactly. A new joiner is someone where the last name and first initial do not exist within the original organization list.

The new joiners are then separated into two categories. A “clear” category exists where there is no other individual with that last name and first initial. An “unclear” category exists where there is more than one other person with the same first initial and last name. A human operator will then have to determine if the uncleared data matches any pre-existing names, or if the uncleared data represents a new joiner.

It will be understood that each of the elements described above, or two or more together, also may find a useful application in other types of constructions differing from the types described above.

While the invention has been illustrated and described as embodied in a method of managing and updating a contact database, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. A method of managing a contact database, comprising the steps of:
a) offering an initial incentive to respective individuals to store contact information in the database, and providing the initial incentive after the contact information has been stored; and
b) offering subsequent incentives to the respective individuals to update their contact information, and providing each subsequent incentive after the contact information has been updated.

2. The method of claim 1; and further comprising the step of managing the database online through a network of interconnected computers.

3. The method of claim 2; and further comprising the step of generating requests from a database manager to the respective individuals that the contact information be updated prior to the step of providing each subsequent incentive.

4. The method of claim 3, wherein the generating step is performed by transmitting a request message by electronic mail to the respective individuals.

5. The method of claim 4, wherein the generating step is performed by automatically transmitting the request message after a predetermined period of time in which the contact information has not been updated.

6. The method of claim 1, wherein the providing steps are performed by delivering at least one of the incentives as a financial reward.

7. The method of claim 1, wherein the providing steps are performed by awarding scoring points, and by delivering at least one of the incentives when a sum of the scoring points equals a predetermined value.

8. The method of claim 7, wherein the contact information has different data fields of different scoring worth.

9. The method of claim 1; and further comprising the step of identifying each individual by an identifier, and by enabling access to at least some of the contact information by presenting the identifier to the manager.

10. The method of claim 9, wherein the contact information has public data fields and private data fields, and wherein the enabling step is performed by granting access only to the public data fields.

11. The method of claim 9, wherein the access enabling step includes the step of sending a communication to the individual identified by the identifier.

12. The method of claim 11, wherein the communication is a gift.

13. A method of updating a contact database, comprising the steps of:
a) storing contact information indicative of individuals in the database;
b) generating requests from a database manager to the individuals that the contact information be updated; and
c) providing an incentive to a respective individual if the contact information for the respective individual has been updated in response to a respective request.

14. The method of claim 13; and further comprising the step of managing the database online through a network of interconnected computers.

15. The method of claim 14, wherein the generating step is performed by transmitting a request message by electronic mail to the respective individuals.

16. The method of claim 15, wherein the generating step is performed by automatically transmitting the request message after a predetermined period of time in which the contact information has not been updated.

17. The method of claim 13; and further comprising the step of identifying each individual by an identifier, and by enabling access to at least some of the contact information by presenting the identifier to the manager.

18. The method of claim 17, wherein the contact information has public data fields and private data fields, and wherein the enabling step is performed by granting access only to the public data fields.

19. The method of claim 17, wherein the access enabling step includes the step of sending a communication to the individual identified by the identifier.

20. The method of claim 19, wherein the communication is a gift.
